(19) United States
(12) Patent Application Publication
(10) Pub. No.: US 2007/0286014 A1
(43) Pub. Date: Dec. 13, 2007

(54) Stirring rod

(75) Inventor: Chang-Fa Lee, Taipei (TW)

Correspondence Address: BACON & THOMAS, PLLC, 625 SLATERS LANE, FOURTH FLOOR, ALEXANDRIA, VA, 22314, US

(73) Assignee: LEO INTERNATIONAL LIMITED, TAIPEI (TW)

(21) Appl. No.: 11/808,291

(22) Filed: Jun. 8, 2007

(30) Foreign Application Priority Data
Jun. 12, 2006 (TW) 095210226

(51) Int. Cl. B01F 7/00

(52) U.S. Cl. 366/129; 366/308; 366/343

(57) ABSTRACT

A stirring rod includes a soft pipe having a protrusion at an end, an open end at another end, and one or more grooves at the periphery of the pipe. A rod is inserted into the pipe, and the length of the rod sheathed into the pipe is shorter than the length of the pipe. The rod and the pipe are latched by the latch, such that when the pipe is compressed by the rod to spread open the groove, the position adjacent to each groove is extended outward, and the pipe is changed from a linear shape to a shape of an outwardly extended flower, so as to increase the stirring area and give more fun to the use of the stirring rod. After the stirring rod is used, the rod can be pressed gently to separate the latch, and then the pipe resumes its original shape.

### BACKGROUND OF THE INVENTION

1. Field of the Invention

The present invention relates to a stirring rod, and more particularly to a stirring rod extended linearly outward to form the shape of a flower by means of a length difference and a use of different materials, so as to increase the stirring area and give more fun to the use of the stirring rod.

2. Description of the Related Art

Referring to FIG. 1 for a traditional stirring rod, the stirring rod is a rod made of any material, and an end of the rod has a protrusion, such that when the rod is used for stirring, the rod is in a linear form, and thus the stirring area is very limited and the rod allows not much changes. Besides the stirring function, such rod gives no fun to its use, which is definitely not a good design.

### SUMMARY OF THE INVENTION

In view of the foregoing shortcomings of the prior art, the inventor of the present invention based on years of experience in the related industry to conduct extensive researches and experiments, and finally developed a stirring rod in accordance with the present invention to overcome the shortcomings of the prior art.

The primary objective of the present invention is to provide a stirring rod, comprising: a pipe made of a soft material, and an end of the pipe has a protrusion, and another end of the pipe is in the form of an open end, and the periphery of the pipe has one or more axially extended grooves with a predetermined interval from each other; and a rod made of a hard material is inserted into the pipe, and the length of the rod sheathed into the pipe is shorter than the length of the pipe, such that when the pipe is squeezed and compressed by the rod to spread open the groove, the position adjacent to each groove is extended outward, and the pipe is changed from a linear form into the shape of an outwardly extended flower, so as to increase the stirring area. After the rod is withdrawn, the rod resumes its original shape, so as to give more fun to the use of the stirring rod.

Another objective of the present invention is to provide a stirring rod having a latch separately disposed at the connecting position of the pipe and the protrusion and at an end of the rod, such that when the rod is inserted into the pipe, the rod and the pipe are fixed with each other by the latch. Since the pipe is made of a soft material, therefore the rod can be twisted to separate the rod from the pipe when the pipe is inclined.

A further objective of the present invention is to provide a stirring rod having a second latch disposed at an open end of the pipe and at a position with a predetermined distance from a distal edge of the rod, such that when the rod and the pipe are assembled, the second latches are latched with each other. When the rod is inserted into the pipe, the rod is fixed and combined with the pipe, such that the open end of the pipe cannot slide further.

To make it easier for our examiner to understand the present invention, the following detailed description with reference to the accompanying drawings of a preferred embodiment is given for example, but such preferred embodiment is not intended to limit the scope of the present invention.

### BRIEF DESCRIPTION OF THE DRAWINGS

FIG. 1 is a schematic view of a conventional stirring rod;

FIG. 2 is a perspective view of a first preferred embodiment of the invention;

FIG. 3 is a section view of a first preferred embodiment of the invention;

FIG. 4 is a perspective view of a second preferred embodiment of the invention;

FIG. 5 is a schematic view of assembling movements of a first preferred embodiment of the invention;

FIG. 6 is another schematic view of assembling movements of a first preferred embodiment of the invention;

FIG. 7 is a section view of assembling movements of a first preferred embodiment of the invention;

FIG. 8 is a section view of assembling movements of a first preferred embodiment of the invention;

FIG. 9 is a schematic view of separating a pipe from a rod in accordance with a first preferred embodiment of the invention;

FIG. 10 is a perspective view of a third preferred embodiment of the invention; and

FIG. 11 is a schematic view of assembling movements of a third preferred embodiment of the invention.

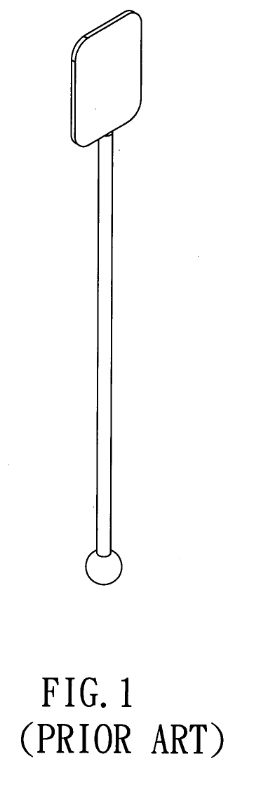

### DETAILED DESCRIPTION OF THE PREFERRED EMBODIMENTS

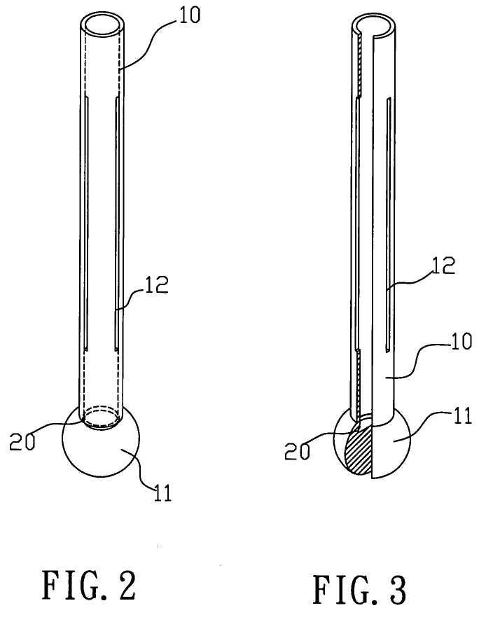

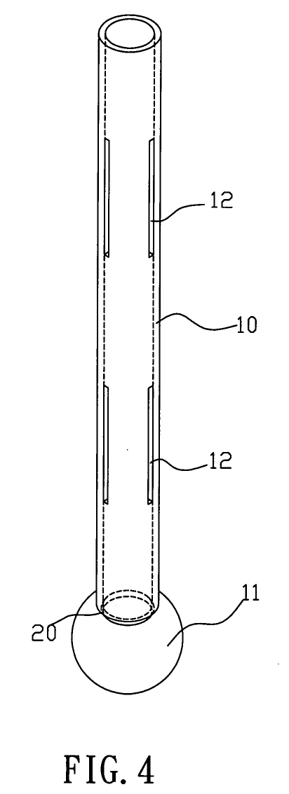

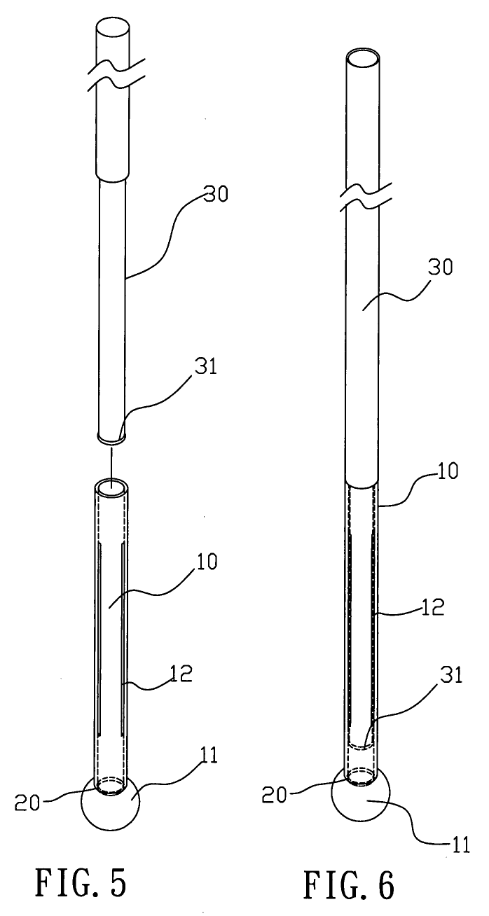

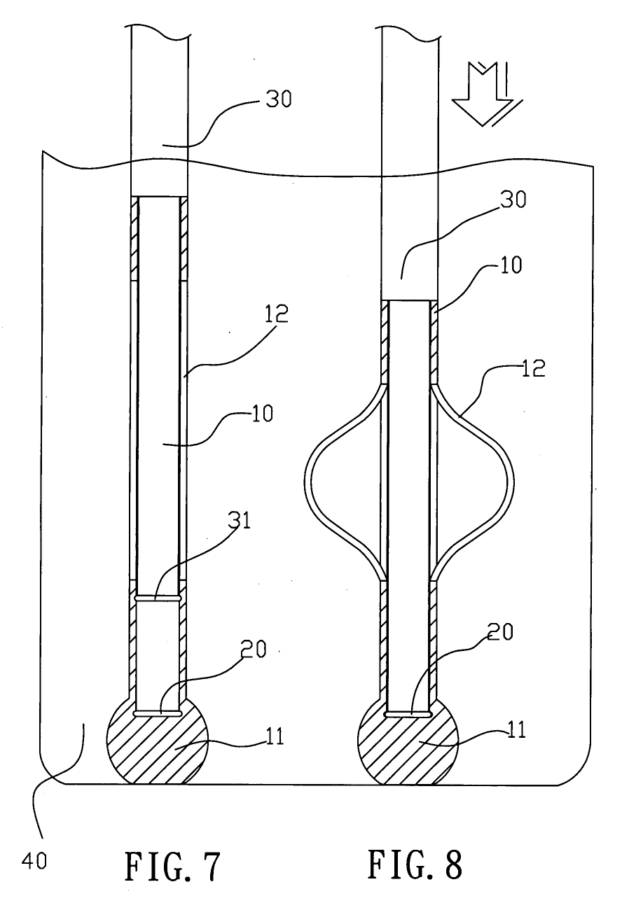

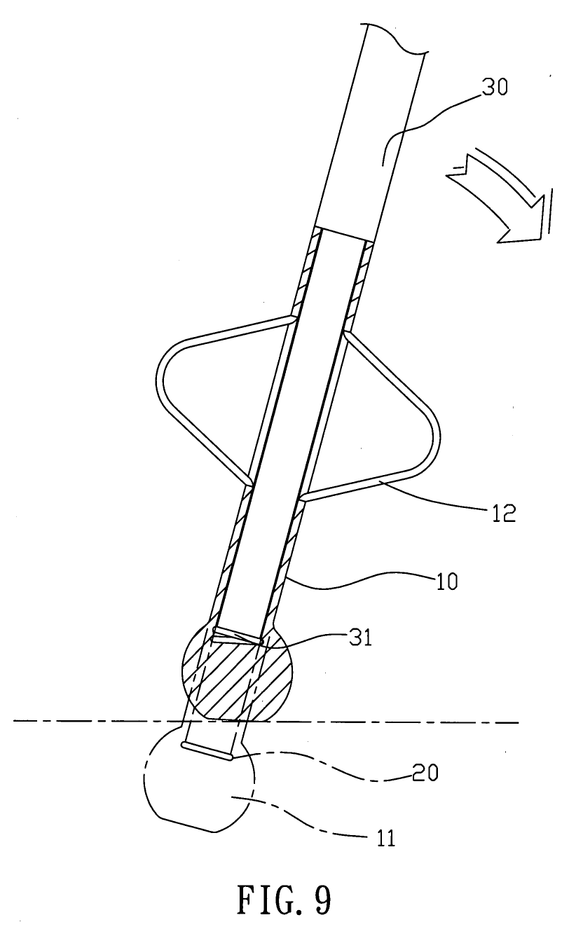

Referring to FIGS. 2 to 4 for a stirring rod of the invention, the stirring rod includes a pipe 10 made of a soft material which is silicon in this embodiment, and a protrusion 11 (which can be a ball in this embodiment, but persons skilled in the art can adopt an element of other shapes for the same purpose) is disposed at an end of the pipe 10, and a latch 20 (which is a groove in this embodiment as shown in FIG. 3) is disposed at the connecting position of the protrusion 11 and the pipe 10, and another end of the pipe 10 is in the form of an open end, and the periphery of the pipe 10 has one or more axially extended grooves 12, and the grooves 12 maintain a predetermined interval apart from each other, and the grooves 12 are disposed alternately along the vertically up and down direction (as shown in FIG. 4). Referring to FIGS. 5 to 8, a rod 30 is inserted into the open end of the pipe 10, and the rod 30 is made of a hard material which is acrylic in this embodiment, and the rod 30 is tapered upward, and the length of the rod 30 is longer than the length of the pipe 10, and the rod 30 has a latch 31 disposed at a narrower edge, and the latch 31 which is a flange in this embodiment corresponds with the latch 20 of the pipe 10, such that when the rod 30 is inserted into the open end of the pipe 10, the rod 30 abuts the position of connecting the tapered rod 30, and thus the open end of the pipe 10 cannot slide further. Since the length of the narrower end of the rod 30 is shorter than the length of the pipe 10, the pipe 10 will be squeezed and compressed by the rod 30 to spread open the groove 12 when the rod 30 inserted into the pipe 10 is placed into a drinking cup 40, and the rod 30 presses the pipe 10, so that the position adjacent to each groove 12 is extended outward, and the pipe 10 is changed from a linear shape to a shape of outwardly extended flower, until the latch 20 of the pipe 10 is latched with the latch 31 of the rod 30, and the pipe 10 maintains its shape of outwardly extended flower, so as to increase the stirring area (as shown in FIGS. 7 and 8). In FIG. 9, the combined rod 30 and pipe 10 can be inclined, and the rod is pressed and rotated, after the use of the stirring rod, so that both latch 20 and latch 31 are loosened from each other to resume the pipe 10 to its original shape, and give more fun to the use of the stirring rod.

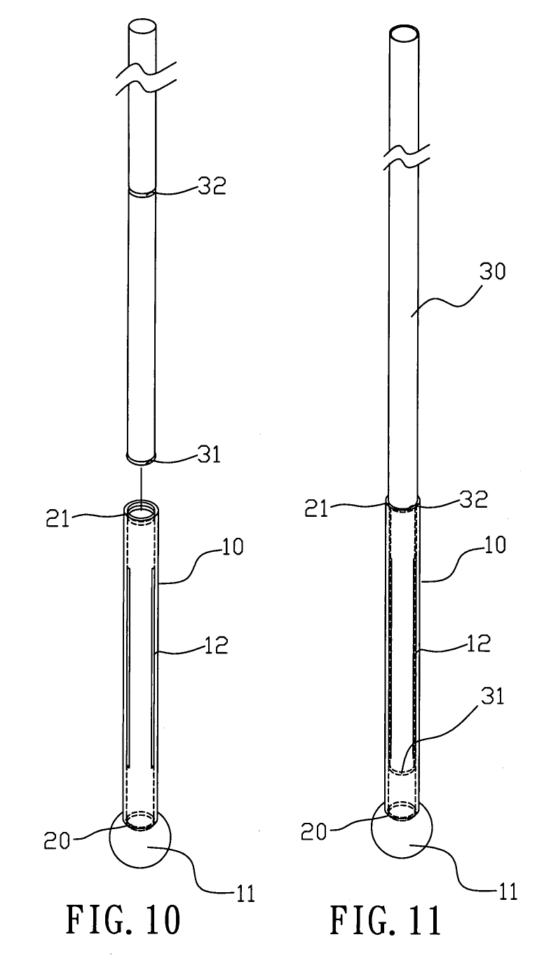

Referring to FIGS. 10 and 11 for a third preferred embodiment of the present invention, a second latch is disposed separately on the pipe 10 and the rod 30, and the open end of the pipe 10 has a latch 21, and a corresponding latch 32 disposed at a predetermined distance from an edge of the rod 30, such that when the pipe 10 and the rod 30 are assembled, the second latches 21, 32 are latched with each other, and the pipe 10 is fixed with the rod 30, and the open end of the pipe cannot slide further.

In summation of the above description, the stirring rod of the present invention comes with a simple structure and a special function to improve a consumer's willingness to purchase, and enhances the performance than the conventional structure and further complies with the patent application requirements and is duly filed for patent application.

While the invention is described in some detail with reference to certain illustrated embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A stirring rod, comprising:
a rod, made of a hard material, and having a latch disposed at a distal end of the rod; characterized in that:
a pipe, having an open end and a protrusion corresponding to the open end, and the protrusion is integrally formed with the pipe, and the pipe is made of a soft material and sheathed around the periphery of the rod; and a latch is disposed adjacent to the connecting position of the protrusion and the pipe, and the periphery of the pipe has one or more axially extended grooves; and the length of the rod sheathed into the pipe is shorter than the length of the pipe, such that when the pipe is squeezed and compressed by the rod to spread open the groove, the position adjacent to each groove is extended outward, and the pipe is changed from a linear shape to a shape of an outwardly extended flower, and the shape of outwardly extended flower can be maintained by the latch of the rod and the pipe, so as to increase the stirring area and give more fun to the use of the stirring rod, and after the stirring rod is used, the rod can be pressed gently to separate the latch, and then the pipe will resume its original shape.

2. The stirring rod as recited in claim 1, wherein the pipe is made of silicon.

3. The stirring rod as recited in claim 1, wherein the rod is made of acrylic.

4. The stirring rod as recited in claim 1, wherein the protrusion is in a spherical shape.

5. The stirring rod as recited in claim 1, wherein the latch includes a groove and a flange.

6. The stirring rod as recited in claim 1, further comprising a second latch separately disposed at the open end of the pipe, and at a position with a predetermined distance from a distal edge of the rod, such that the pipe is fixed and combined with the rod, and the open end of the pipe stops sliding.

7. The stirring rod as recited in claim 6, wherein the second latch includes a groove and a flange.
